(19) United States
(12) Patent Application Publication
(10) Pub. No.: US 2018/0249056 A1
(43) Pub. Date: Aug. 30, 2018

(54) MOBILE TERMINAL AND METHOD FOR CONTROLLING SAME

(71) Applicant: LG ELECTRONICS INC., Seoul (KR)

(72) Inventors: Jumin CHI, Seoul (KR); Younghoon SONG, Seoul (KR); Hyungtae JANG, Seoul (KR); Sooyoung HER, Seoul (KR)

(73) Assignee: LG Electronics Inc., Seoul (KR)

(21) Appl. No.: 15/752,881

(22) PCT Filed: Aug. 18, 2015
(86) PCT No.: PCT/KR2015/008591

§ 371 Date: Feb. 14, 2018

(51) Int. Cl. H04N 5/232; G06F 3/01; G06F 3/16; G06F 1/16

(52) U.S. Cl. CPC H04N 5/232; G06F 1/163; G06F 3/167; G06F 3/017

(57) ABSTRACT

The present invention relates to a mobile terminal and a method for controlling the mobile terminal. The present invention determines a user's emotional state from applause sounds according to the user's gestures and records an event corresponding to a current situation according to the user's emotional state, so that in addition to a case where the user consciously performs recording, it is possible to leave, on record, a situation according to the user's unconscious emotional state by means of a simple interface.

### TECHNICAL FIELD

The present invention relates to a mobile terminal and a method for controlling the same to increase applicability of a watch type mobile terminal used in connection with a portable terminal of a user.

### BACKGROUND ART

Terminals can be divided into a mobile/portable terminal and a stationary terminal according to mobility. Further, mobile terminals can be divided into a handheld terminal and a vehicle mounted terminal according to user portability.

Functions of mobile terminals are diversified. For example, mobile terminals have functions of data and audio communication, photographing using a camera, capturing video, recording sound, reproducing music files using a speaker system and displaying images or video on a display. Some terminals additionally have an electronic game playing function or a multimedia player function. Particularly, recent mobile terminals can receive multicast signals providing visual content such as broadcast, video and TV programs.

### DISCLOSURE

### Technical Problem

Meanwhile, recent reaches on a wearable computing device have raised interest in how to use the wearable computing device. The wearable computing device refers to clothes, watches, glasses and other computing devices that a user can wear. Although mobile terminals such as smartphones and tablet PCs can be conveniently used with a user's finger or a stylus, it may be inconvenient for a user to always carry a mobile terminal in a pocket, a bag or a hand. On the other hand, the wearable computing system can be worn on a user's wrist or worn by a user like glasses and thus the user can carry it more easily than conventional mobile terminals. There is a need for research and development of various user interfaces which can improve utilization of the wearable device by applying the intention of a user to the wearable device according to conscious or unconscious action of the user wearing the wearable device.

### Technical Solution

An object of the present invention is to provide a watch-type mobile terminal and a method for controlling the same to provide a user interface through which a user can easily and efficiently control the watch-type mobile terminal.

Another object of the present invention is to provide a watch-type mobile terminal and a method for controlling the same to provide a user interface through which recording can be performed on the basis of the intention of a user according to a gesture of the user wearing the watch-type mobile terminal.

Yet another object of the present invention is to provide a watch-type mobile terminal and a method for controlling the same to recognize clapping of a user wearing the watch-type mobile terminal as an event and recording and storing the event.

Another object of the present invention is to provide a watch-type mobile terminal and a method for controlling the same to provide various user interfaces through which a situation in which a user wearing the watch-type mobile terminal is clapping can be recoded depending on the user's emotional state sensed through a clapping pattern.

According to one of embodiments of the present invention, a watch-type mobile terminal, comprising: a recording unit; an input unit configured to receive an audio signal; an audio signal processor configured to detect clapping sound from the input audio signal; a memory configured to store a clapping pattern causing a recording function to be started; and a controller configured to drive the recording unit to start recording when the detected clapping sound corresponds to the stored clapping pattern, and when an input for ending the recording function is sensed, to end recording of the recording unit and store the recorded event in the memory.

Wherein the recording unit includes at least one of a microphone and a camera, wherein the controller may perform recording by executing at least one of an application of driving the microphone to record audio and a camera application.

Wherein the input for ending the recording function may include at least one of an input of clapping sound corresponding to the stored clapping pattern during execution of the recording function, sensing of a case in which the recording function is continuously executed for a predetermined time or longer, and sensing of location change acquired through a location information module.

The watch-type mobile terminal may further comprise a body; a band connected to the body and configured to be worn on a user's wrist; a display unit provided on the front side of the body and configured to output information; a sensing unit provided to at least one of the rear side of the body and the inside of the band and configured to sense a biosignal of the user by contacting the user's wrist while the band is worn on the user's wrist; and an analysis unit configured to analyze the biosignal to determine an emotional state of the user.

Wherein the biosignal includes a heartbeat signal of the user, and the analysis unit analyzes a pattern of the heartbeat signal to determine an emotional state of the user.

wherein the audio signal processor may acquire a pattern according to the number of times of clapping of the detected clapping sound, strength of the clapping sound, and a combination of multiple clapping sounds through signal processing.

Wherein the controller may control recoding of the recording unit on the basis of the pattern of the clapping sound detected by the audio signal processor and the emotional state of the user.

Wherein the controller may automatically execute recording when the strength of the clapping sound is equal to or greater than a predetermined strength and the emotional state of the user is a first state.

Wherein the controller may provide an inquiry window for inquiring whether to start recording to the display unit when the strength of the clapping sound is equal to or greater than a predetermined strength and the emotional state of the user is a second state or when the strength of the clapping sound is less than the predetermined strength and the emotional state of the user is the first state.

Wherein the controller may provide a watch mode screen to the display unit without starting recording when the strength of the clapping sound is less than the predetermined strength and the emotional state of the user is the second state.

The watch-type mobile terminal may further comprise a communication unit configured to perform communication with a paired external electronic device, wherein the clapping pattern causing the recording function to be started includes a clapping pattern in which clapping sound having a specific rhythm is input predetermined number of times, and wherein the controller may perform recording through the recording unit and simultaneously drive a recording unit of the external electronic device to control recording to be performed in the external electronic device upon sensing the clapping pattern, to receive results of recording performed in the external electronic device through the communication unit and to provide the results to the display unit.

Wherein the controller is configured to receive additional information related to a current event recorded in the recording unit or the external electronic device through the communication unit and to provide the additional information to the display unit when a predetermined input applied to a bezel region of the display unit is received.

Wherein the controller may provide a list including a plurality of recorded events stored in the memory to the display unit when clapping sound in a predetermined pattern is sensed or release of the watch-type mobile terminal from the user's wrist is sensed after recording is completed.

Wherein the controller may sequentially provide the plurality of recorded events to the display unit according to a predetermined input applied to the bezel region of the display unit.

The watch-type mobile terminal may further comprise a location information module, wherein the controller may tag the recorded event with a location acquired through the location information module.

Wherein the controller may search the memory for information on events recorded at a first location and provide search results to the display unit when the location of the mobile terminal is the first location.

Wherein the controller may provide, to the display unit, information on other events recorded at the first location or other events that are provided at the first location but not recorded according to a predetermined input applied to the bezel region of the display unit.

The watch-type mobile may further comprise a communication unit, wherein the controller may control a communication link with an external display device to be established through the communication unit when the watch-type mobile terminal is set in a cradle to enter a charging mode, and control at least one recorded event stored in the memory to be displayed through the external display device.

According to other of embodiments of the present invention, a method of controlling a watch-type mobile terminal, comprising: storing a clapping pattern causing a recording function to be started; detecting clapping sound from an input audio signal; driving a recording unit to start recording when the detected clapping sound corresponds to a pre-stored clapping pattern; and ending recording of the recording unit and storing the recorded event in a memory when an input for ending the recording function is sensed.

The method may further comprise sensing a biosignal of a user through a sensing unit; analyzing the biosignal through an analysis unit to determine an emotional state of the user; and controlling recording of the recording unit on the basis of a clapping sound pattern detected by an audio signal processor and the emotional state of the user.

### Advantageous Effects

According to the watch-type mobile terminal and the method for controlling the same according to the present invention, the following advantages are obtained.

According to the present invention, it is possible to provide a user interface through which a user can easily and efficiently control the watch-type mobile terminal.

In addition, according to the present invention, it is possible to provide a user interface through which recording can be performed on the basis of the intention of the user according to a gesture of the user wearing the watch-type mobile terminal.

Furthermore, according to the present invention, it is possible to recognize clapping of a user wearing the watch-type mobile terminal as an event and to record and store the event.

Moreover, according to the present invention, it is possible to provide various user interfaces through which a situation in which a user wearing the watch-type mobile terminal is clapping can be recoded depending on the user's emotional state sensed through a clapping pattern.

### DESCRIPTION OF DRAWINGS

FIG. 1 is a block diagram of a watch-type mobile terminal in accordance with the present invention.

FIG. 2 is a perspective view illustrating an example of a watch-type mobile terminal 300 in accordance with one embodiment of the present invention.

FIG. 3 illustrates an operating environment of a watch-type mobile terminal according to one embodiment of the present invention.

FIG. 4 is a flowchart of a method for controlling a mobile terminal according to a first embodiment of the present invention.

FIGS. 5 and 6 are diagrams for describing examples in which the method for controlling a mobile terminal according to the first embodiment of the present invention is implemented.

FIG. 7 is a flowchart of a method for controlling a mobile terminal according to a second embodiment of the present invention.

FIGS. 8a to 8c are diagrams for describing an example of determining an emotional state of a user by analyzing a biosignal of the user according to the second embodiment of the present invention.

FIGS. 9a to 9c are diagrams for describing an example of controlling whether to performing recording depending on a clapping pattern and an emotional state of a user according to the second embodiment of the present invention.

FIG. 10 is a flowchart of a method for controlling a mobile terminal according to a third embodiment of the present invention.

FIGS. 11a to 12 are diagrams for describing an example of providing additional information of a recorded event according to the third embodiment of the present invention.

FIG. 13 is a flowchart of a method for controlling a mobile terminal according to a fourth embodiment of the present invention.

FIGS. 14a and 14b are diagrams for describing an example of implementing a method of retrieving a recorded event according to the fourth embodiment of the present invention.

FIG. 15 is a flowchart of a method for controlling a mobile terminal according to a fifth embodiment of the present invention.

FIG. 16 is a diagram for describing an example of providing recorded event information having location information tagged thereto according to the fifth embodiment of the present invention.

FIG. 17 is a flowchart of a method for controlling a mobile terminal according to a sixth embodiment of the present invention.

FIGS. 18 to 20 are diagrams for describing an example of implementing a method of displaying a recorded event in a state in which the watch-type mobile terminal has been released from a user's wrist according to the sixth embodiment of the present invention.

FIG. 21 is a diagram for describing an example in which clapping recommended for a user is displayed as a graphical object according to one embodiment of the present invention.

FIG. 22 is a diagram for describing an example of sharing a recorded event according to one embodiment of the present invention.

FIG. 23 is a diagram for describing an example of storing and displaying a recorded event according to one embodiment of the present invention.

FIG. 24 is a diagram for describing an example of providing appropriate information to a user depending on a clapping pattern and an emotional state of the user according to one embodiment of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra-books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

Embodiments with respect to control methods which can be implemented in a mobile terminal configured as above will be described below with reference to the attached drawings. It is obvious to those skilled in the art that the present invention can be embodied in other specific forms without departing from the spirit and essential characteristics of the present invention.

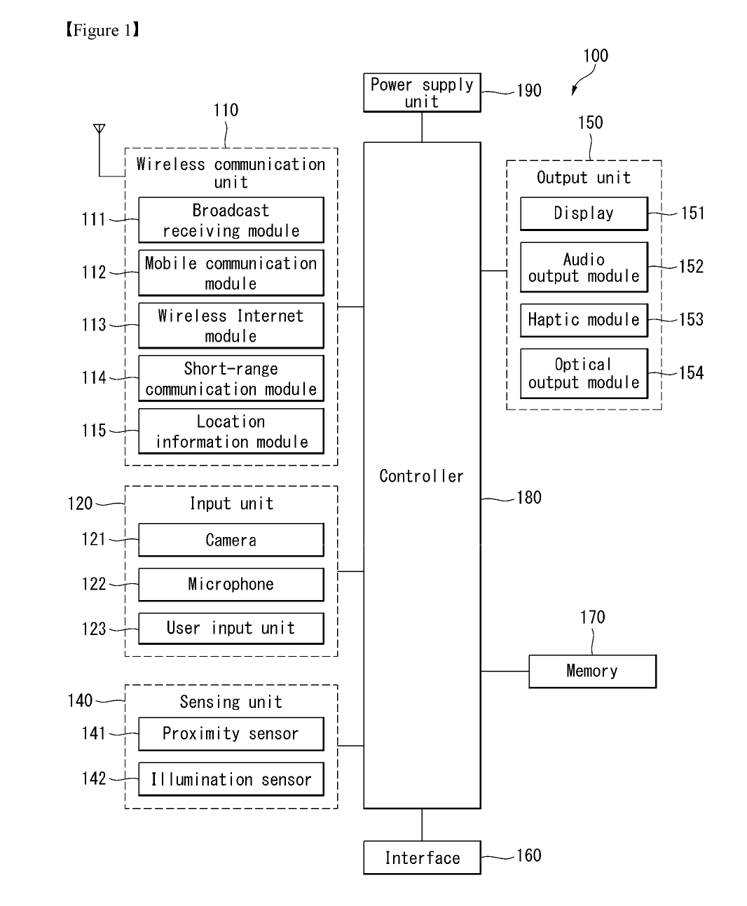

FIG. 1 is a block diagram for describing a watch-type mobile terminal in accordance with the present invention.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

More specifically, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located. The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, and the like) for allowing a user to input information. Data or image data is obtained by the input unit 120 and may be analyzed and processed into control commands of a user.

The sensing unit 140 is typically implemented using one or more sensors configured to sense internal information of the mobile terminal, the surrounding environment of the mobile terminal, user information, and the like. For example, the sensing unit 140 is shown having a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components described above, or activating application programs stored in the memory 170.

In addition, the controller 180 controls some or all of the components illustrated in FIG. 1 according to the execution of an application program that have been stored in the memory 170. Furthermore, the controller 180 may combine and operate at least two of components included in the mobile terminal 100 to execute the application program.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the aforementioned components may cooperatively operate to realize operation and control of the mobile terminal or a method of controlling the same according to various embodiments which will be described below. In addition, operation and control of the mobile terminal or a method of controlling the same may be realized according to execution of at least one application program stored in the memory 170.

The aforementioned components will be described in more detail with reference to FIG. 1 prior to description of various embodiments realized through the aforementioned mobile terminal 100.

Regarding the wireless communication unit 110, the broadcast receiving module 111 is typically configured to receive a broadcast signal and/or broadcast associated information from an external broadcast managing entity via a broadcast channel. The broadcast channel may include a satellite channel and a terrestrial channel. Two or more broadcast receiving modules may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals include audio call signals, video telephony call signals and/or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access.

The short-range communication module 114 is configured to facilitate short-range communications. Suitable technologies for implementing such short-range communications include Bluetooth™, Radio Frequency IDentification (RFID), Infrared Data Association IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module or a Wi-Fi module. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module. If desired, the location information module 115 may alternatively or additionally function with any of the other modules of the wireless communication unit 110 to obtain data related to the position of the mobile terminal. The location information module 115 is used to acquire a position (or current position) of the mobile terminal and is not limited to a module which directly calculates or acquires the position of the mobile terminal.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. The microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data (or information) corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch (or touch input) applied to the touch screen (or the display unit 151) using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen (or a touch key provided in addition to the touch screen). Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The display unit 151 of the mobile terminal according to an embodiment of the present invention includes a transparent display. In the following description of the structure of the mobile terminal 100 and embodiments, the display unit 151 is referred to as a transparent display 151.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

The above-described mobile terminal according to an embodiment of the present invention may be implemented as a watch type mobile terminal.

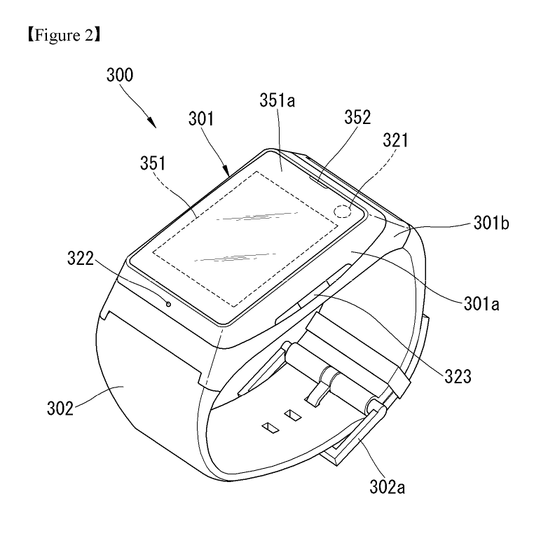

FIG. 2 is a perspective view illustrating one example of a watch-type mobile terminal 300 in accordance with another exemplary embodiment.

Although the mobile terminal is denoted by reference numeral 300 in FIG. 2, differently from FIG. 1, this is for convenience of description. Accordingly, it is assumed that a display unit 351 of the watch-type mobile terminal 300 corresponds to the display unit 151 of the mobile terminal 100 described in FIG. 1 (the two displays execute the same functions). The same applies to units other than the display.

Referring to FIG. 2, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIG. 1.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, the display unit 351 can serve as the user input unit 323 and thus additional function keys may be minimized or eliminated.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

In what follows, embodiments of the present invention will be described. For the convenience of description, this document assumes that the display 151 is a touch screen 151. As described above, a touch screen 151 can carry out both of an information display function and an information input function. However, it should be noted that the present invention is not limited to the assumption. Also, the touch input described in this document can include both of a contact-type and a proximity touch input.

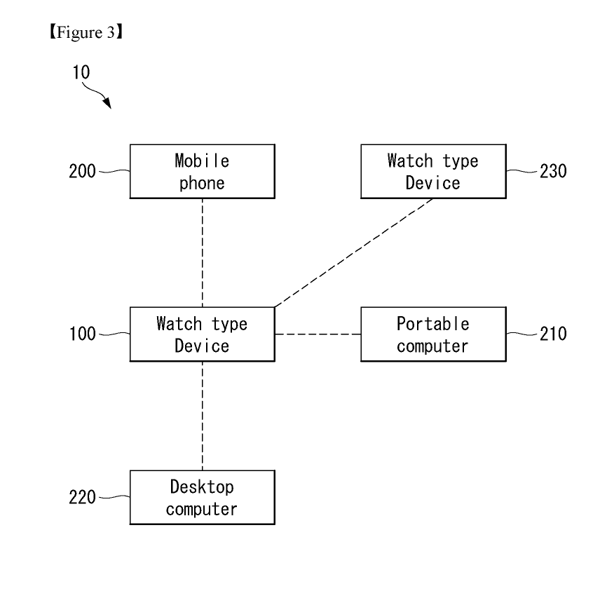

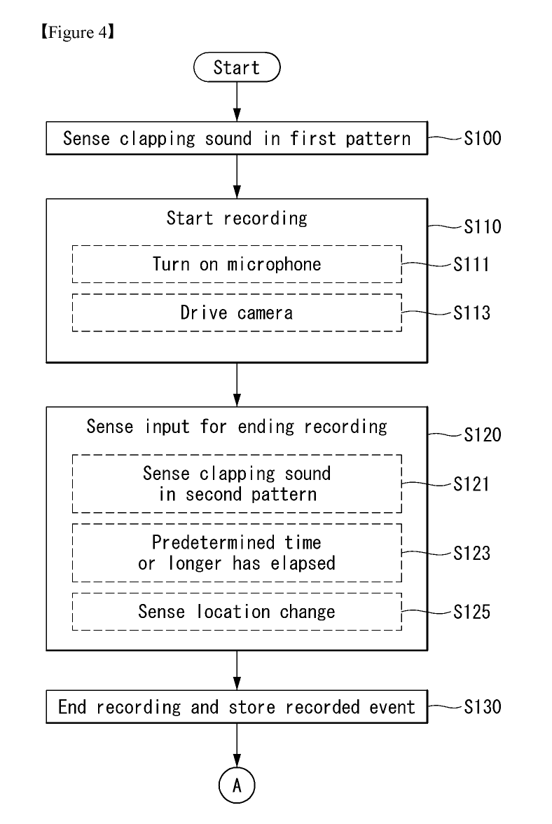

FIG. 3 illustrates an operating environment of a watch-type mobile terminal according to one embodiment of the present invention.

With reference to FIG. 3, in a personal radio environment 10 where the watch-type mobile terminal is operating, users of a plurality of electronic devices are allowed to use the watch-type mobile terminal 100 for displaying or receiving particular information.

The personal radio environment 10 can be activated so that users of the watch-type mobile terminal 100 can interact with a mobile phone 200, a portable computer 210, a desktop computer 220 and/or other watch-type mobile terminal 230. Interaction with the watch-type mobile terminal 100 can be carried out in a wired or wireless manner. For the convenience of the user, the watch-type mobile terminal 100 supports radio interaction with at least one electronic device among one or more external electronic devices 200, 210, 220, 230. At this time, the watch-type mobile terminal 100 can use a pico-net formed among neighboring external electronic devices.

In the following, described will be pairing between the watch-type mobile terminal 100 and an external mobile terminal 200 according to one embodiment of the present invention. For the convenience of description, the watch-type mobile terminal 100 is called a smart watch 100, and the external mobile terminal 200 is called a smartphone 200. The smartphone 200 can correspond to a digital device capable of connecting to the smart watch 100 for communication.

Pairing can refer to connection between the smart watch 100 and the smartphone 200 for data transmission and reception. The smart watch 100 and the smartphone 200 can carry out bilateral data transmission and reception by establishing a connection for communication. The pairing can be implemented by using Bluetooth or Near Field Communication (NFC). As one example, the pairing can be carried out through a user input at the smart watch 100 or the smart phone 200. The user input can be obtained through a separate button prepared for communication connection or through a user interface.

Once a communication connection is established, the smart watch 100 is able to carry out data communication with the smartphone 200 while a session is open. Meanwhile, the smart watch 100 can perform selective data communication with a plurality of external electronic devices 200, 210, 220, 230 by carrying out pairing with the plurality of external electronic devices.

Detecting a paired smart phone 200, the smart watch 100 can provide notification about an event generated from the smartphone 200. The event denotes a change of state generated from the smart phone 200, including reception of a call, text, SNS message, schedule notification, and weather notification. Meanwhile, notification of the event generated from the smart phone 200 is intended to inform the user of the aforementioned event, which can be displayed in the form of text, voice, or vibration.

In one embodiment of the present invention, a predetermined call can be received while the smart watch 100 is paired with the smartphone 200. At this time, the smart watch 100 can have the same phone number as the smartphone 200. If the smartphone 200 receives a call while the two devices are paired with each other, the received call is also delivered to the smart watch 100, and the smart watch 100 can notify the user of the call reception through bell sound or vibration.

Meanwhile, even if call identification numbers of the two devices differ from each other, the smart watch 100 can still be notified of a received call in case the smartphone 200 receives the call as long as the two devices are paired to each other.

In what follows, described will be various embodiments of the present invention where the smart watch 100 is worn by the user on the wrist for most cases, and in case a predetermined event is generated from the smartphone 200 but the user is unable to check the event directly from the smartphone 200, the generated event can still be controlled more conveniently through the smart watch 100.

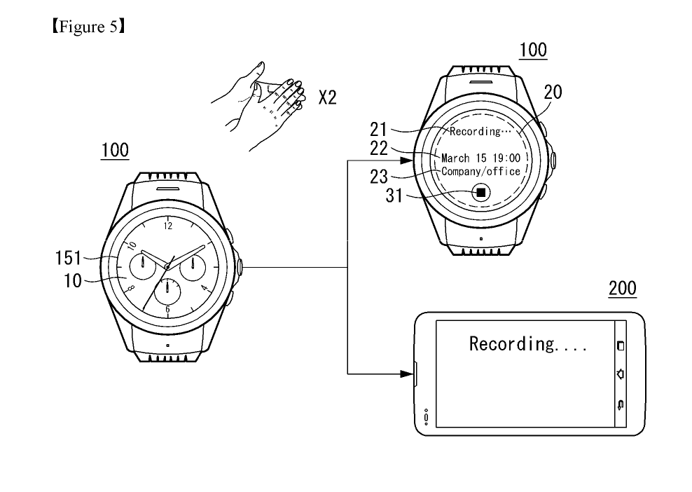

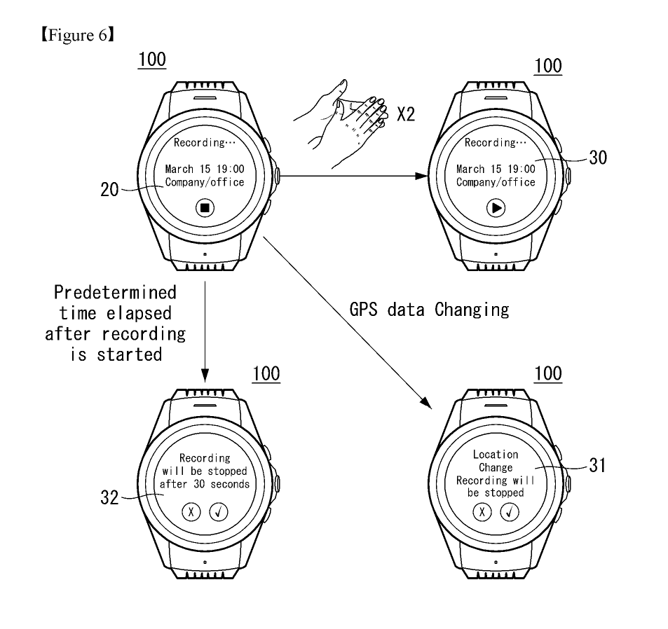

FIG. 4 is a flowchart of a method for controlling a mobile terminal according to a first embodiment of the present invention. FIGS. 5 and 6 are diagrams for describing examples in which the method for controlling a mobile terminal according to the first embodiment of the present invention is implemented.

The method for controlling a mobile terminal according to the first embodiment of the present invention can be implemented in the mobile terminal 100 described above with reference to FIG. 3. Hereinafter, the method for controlling a mobile terminal according to the first embodiment of the present invention and operations of the mobile terminal 100 for implementing the same will be described in detail with reference to the drawings.

Referring to FIG. 4, the controller 180 senses clapping sound in a first pattern (S100).

The mobile terminal 100 may include a predetermined active filter for sensing clapping sound. It is necessary to filter only part of the sound spectrum of clapping sound through the active filter. The sound spectrum of clapping sound is a signal having white noise widely distributed over more than 10 kHZ. The active filter for filtering clapping sound is a bandpass filter of a higher frequency band than normal human voice, for example, 5 kHz, and can be designed to be insensitive to normal human voice.

The mobile terminal 100 may prestore a predetermined clapping pattern which causes a recording function to be started in the memory. The clapping pattern can be set by a user. A plurality of clapping patterns may be set by the user. Accordingly, the mobile terminal may be configured to perform a recording operation for a clapping pattern of unconscious clapping of the user as well as a predetermined clapping pattern intentionally input by the user. An embodiment in which the recording operation is performed according to a clapping pattern of unconscious clapping of the user will be described in more detail through a second embodiment of the present invention.

The controller 180 may control a recording unit to start recording upon sensing the clapping sound in the first pattern (S110).

The recording unit may include the microphone (122 in FIG. 1) and the camera (121 in FIG. 1). That is, the controller 180 can drive the microphone and record the current event according to the clapping sound. Events recorded through the microphone may include only audio signals. However, events recorded through the camera may include both video and audio signals. The controller 180 may drive at least one of the microphone and the camera according to the input clapping pattern and/or an emotional state of the user to record an event at the clapping sound input time in real time.

The recorded event may include an event with respect to the surrounding situation of the user. For example, when the user wearing the watch-type mobile terminal is located in a stadium or a concert hall, it is possible to easily record and store a situation that the user wants through a predetermined clapping pattern without a step of executing an additional recording application.

When an input for ending recording is detected while a predetermined event is recorded through the recording unit (S120), the controller 180 may end recording and store the recorded event in the memory (S130).

The input for ending recording may be an input for sensing clapping sound in a second pattern (S121). That is, the recording function can be started by clapping sound in the first pattern and ended by clapping sound in the second pattern. Here, clapping sound in the second pattern may be the same as clapping sound in the first pattern. For example, when clapping in the first pattern is clapping three times, the controller 180 can start recording according to clapping three times and end recording upon sensing clapping three times during recording. In one embodiment, a clapping pattern that causes recording to be started may be set to be the same as or different from a clapping pattern that causes recording to be ended, and the user may set various clapping patterns which cause recording to be started and ended.

Further, the input for ending recording may include a case in which recording is continuously performed for a specific time (S123). The controller 180 may automatically end recording and store the recorded event in the memory when three minutes elapse from the start of recording due to clapping sound.

The input for ending recording may include change of the location of the mobile terminal 100, detected through a location information module (S125). That is, when an abrupt change in the location of the mobile terminal 100 is detected after recording is started by clapping sound in a state in which the location of the mobile terminal 100 is not changed, the controller 180 may determine that no more recording is required and stop recording. For example, when recording is started by clapping sound while the mobile terminal 100 is being moved, a case in which real-time location change occurs may be determined to be a situation which requires recording. In this case, when movement of the mobile terminal 100 is stopped, location change does not occur and thus the controller 180 can determine that no more recording is necessary and stop recording.

Referring to FIG. 5, the user wearing the watch-type mobile terminal 100 can clap a predetermined number of times (e.g., twice).

The controller 180 may recognize the clapping sound as a command for activating the recording function and activate the sound recording function. The controller 180 may provide a message 21 indicating a recording state, a recording time 22, a recording place 23 and a control key 31 for controlling recording to the display unit 151.

Further, the controller 180 may generate a control signal which causes the recording function to be activated in an external electronic device 200 paired with the mobile terminal 100 according to the clapping sound and transmit the control signal to the external electronic device 200. Accordingly, the external electronic device 200 can receive the control signal from the watch-type mobile terminal 100 and activate the recording function.

Referring to FIG. 6, when predetermined clapping sound is sensed during recording (20) in the watch-type mobile terminal 100, the clapping sound can be recognized as a recoding end command. That is, when a clapping pattern that activates the recording function is input again, the controller 180 can end recording and store the recorded event (30). When change in data of a GPS included in the watch-type mobile terminal 100 is sensed, the data change may be recognized as a recording end command. In this case, the controller 180 may automatically end recording or provide an inquiry window for inquiring whether to end recording to the display unit 151 according to the GPS data change (31). When a predetermined time (e.g., 30 seconds) has elapsed from the start of the recording function, the controller 180 may recognize the lapse of time as a recording end command. In this case, the controller 180 may also provide the inquiry window for inquiring whether to end recording to the display unit 151 (32).

Although an example of starting recording and ending recording according to sensed clapping sound has been described, the present invention is not limited thereto. For example, the GPS function may be activated or web information that can be obtained at the location of the mobile may be provided according to a clapping pattern input by the user in addition to activation of a recording means.

According to one embodiment of the present invention, an emotional pattern of a user may be determined through clapping sound, recording may be performed when the emotional pattern of the user is determined to be a positive state and recording may not be performed when the emotional pattern is determined to be a negative state. Hereinafter, an embodiment of controlling recording according to an input clapping pattern and a user's emotional state will be described.

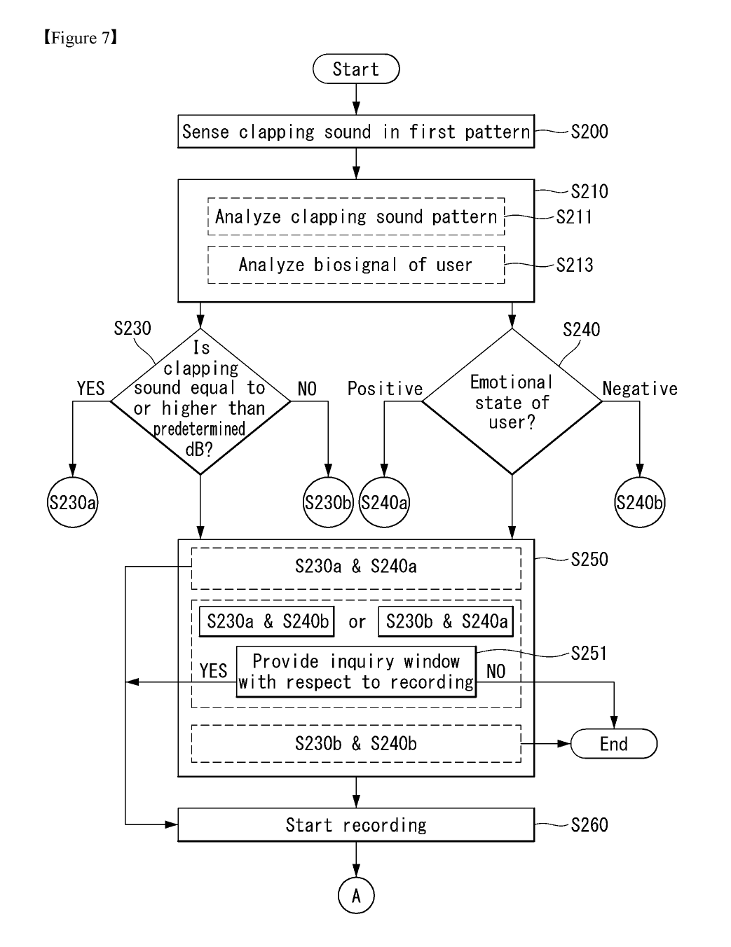

FIG. 7 is a flowchart of a method for controlling a mobile terminal according to a second embodiment of the present invention.

The method for controlling a mobile terminal according to the second embodiment of the present invention can be implemented in the mobile terminal 100 described above with reference to FIGS. 1 to 3. Hereinafter, the method for controlling a mobile terminal according to the second embodiment of the present invention and operations of the mobile terminal 100 for implementing the same will be described in detail with reference to the drawings. The second embodiment of the present invention can be implemented on the basis of the first embodiment.

Referring to FIG. 7, the controller 180 may sense clapping sound in the first pattern (S200). Step S200 corresponds to the above-described step S100.

The controller 180 may analyze the clapping sound upon sensing the clapping sound (S210). That is, the controller 180 may analyze the clapping sound from two viewpoints.

For example, the controller 180 analyzes the pattern of the clapping sound (S210).

The clapping sound pattern may be obtained by sensing an input external audio signal through signal processing of an audio signal processor, detecting clapping sound from the audio signal and acquiring a pattern according to a combination of the number of times of clapping, strength of the clapping sound, and a plurality of clapping sounds. For example, the input clapping pattern may correspond to clapping three times and have strength equal to or greater than a threshold value and a rhythm set by the user from results of analysis of the clapping pattern. According to one embodiment of the present invention, the recording function may be executed when at least one of the number of times of clapping, clapping strength and clapping rhythm set by the user is satisfied, and thus the controller 180 needs to analyze the input clapping pattern through the signal processor. The analyzed clapping pattern may be used to activate the recording function by being combined with information about a user's emotional state.

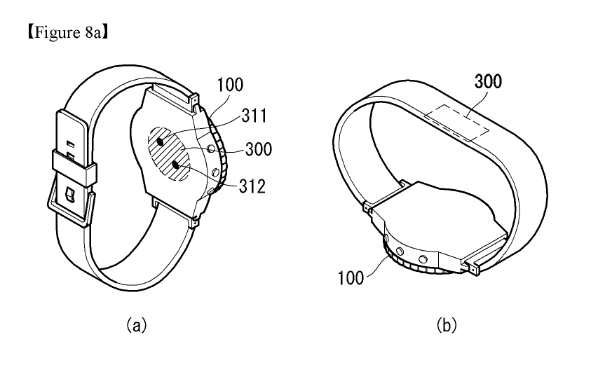

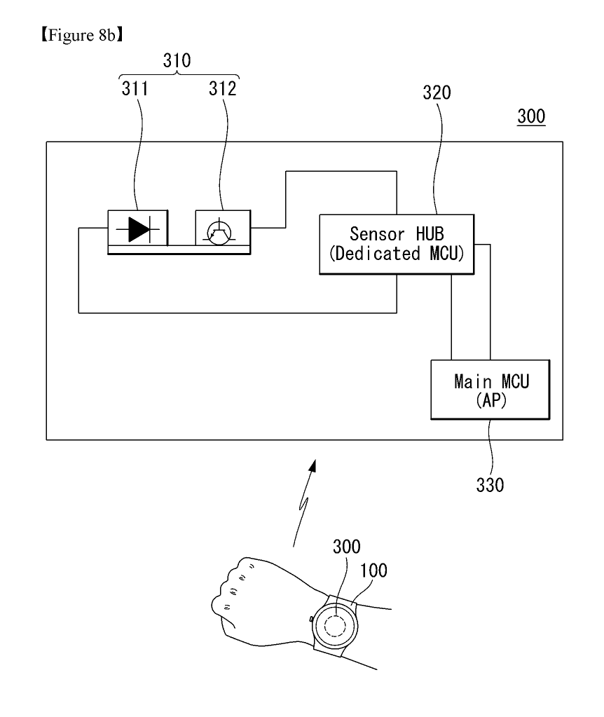

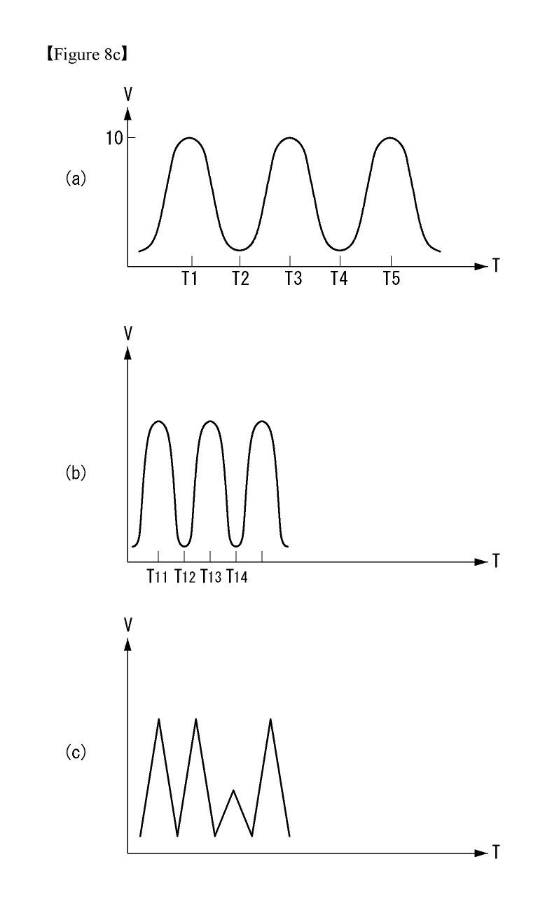

Furthermore, the controller 180 may acquire a biosignal of the user, sensed through a predetermined sensing unit, upon sensing clapping sound according to a gesture of the user. The biosignal of the user may include a heartbeat signal of the user, measured when the mobile terminal 100 contacts a user's wrist. The controller 180 may analyze the pattern of the heartbeat signal to determine the user's emotional state as a positive state or a negative state. The sensing unit and the method of determining a user's emotional state through the biosignal of the user will be described in more detail with reference to FIGS. 8a to 8c.

FIGS. 8a to 8c are diagrams for describing an example of analyzing a biosignal of the user to determine a user's emotional state according to the second embodiment of the present invention.

Referring to FIG. 8a, the watch-type mobile terminal 100 may include a body, a band connected to the body and configured to be worn on a user's wrist, and a display provided to the front side of the body to display information. Further, a sensing unit 300 capable of measuring a biosignal of the user may be provided to the rear side of the body and/or the inner side of the band to sense the biosignal of the user as the band worn on the user's wrist contacts the user's wrist. The mobile terminal 100 may additionally include an analysis unit for analyzing the sensed biosignal to determine a user's emotional state.

The biosignal is generated by the sensing unit 300 contacting the body of the user. For example, the sensing unit 300 may correspond to a watch that is fixed on a user's wrist and contacts at least a region of the user's skin. However, any device which can contact the body of the user to sense a biometric variation of the user can be employed irrespective of the type of the sensing unit 300. For example, the sensing unit may be configured in the form of glasses, earrings, a watch, a bracelet and the like which can consistently contact a region of the body of the user. For example, the biosignal may be generated according to heart rate variation delivered through the user's skin, measured blood flow rate variation and the like.

FIG. 8b is a conceptual view for describing the sensing unit 300. Referring to FIG. 8b, the sensing unit 300 may include a light-emitting unit 311, a light-receiving unit 312, a dedicated MCU 320 and a main MCU 330. The light-emitting unit 311 and the light-receiving unit 312 are arranged side by side on the user's skin. The light-receiving unit 312 senses light emitted from the light-emitting unit 311 and transferred through the user's skin.

On the other hand, the light-emitting unit 311 and the light-receiving unit 312 may be arranged having user's skin therebetween. For example, the sensing unit 300 can be attached to a finger or an earlobe which is a relatively thin body part.

The light-receiving unit may filter an optical variation according to a density difference between blood flow rates and amplify the filtered optical variation to generate a waveform.

The dedicated MCU remains in an activated state or is controlled to be turned on/off at predetermined intervals (e.g., several seconds). The light-receiving unit 312 delivers information about a measured blood flow rate to the dedicated MCU. The dedicated MCU activates the main MCU 330 upon sensing that the blood flow rate received from the light-receiving unit 312 has abruptly changed compared to a predetermined reference variation.

The main MCU 330 may collect a heartbeat cycle pattern of the user on the basis of information collected by the light-receiving unit 312. For example, the main MCU 330 can generate HRV (Heart Rate Variability) information. The heart rate can be analyzed through the HRV information and thus an excited state of the user can be predicted.

Biosignals represented as graphs of FIG. 8c correspond to HRV information received from the sensing unit 300.

That is, the controller 180 receives the biosignal from the sensing unit 300 while clapping sound according to a gesture of the user is input.

In addition, the controller 180 analyzes the emotion of the user on the basis of the biosignal (S213 and S240 in FIG. 7). The controller 180 may predict the emotion of the user through the HRV information.

FIG. 8c is a graph showing a biosignal received from the sensing unit 300. A method of predicting a user's emotion through the biosignal will be described with reference to FIG. 8c.

(a) of FIG. 8c is a graph showing a blood flow rate sensed through the sensing unit 300 when the user is not excited. A uniform heart rate of the user is measured when the user is not excited. That is, the graph shows a uniform heartbeat. The graph showing the heart rate of the user may correspond to the average of blood flow rates of the user. That is, the sensing unit 300 stores graph patterns according to blood flow rates of the user in a stable state in which the user is not excited, and the average graph pattern may be defined as a state in which the user wearing the watch-type mobile terminal is not excited. Accordingly, errors in measurement of heart rates and emotion analysis can be minimized.

For example, when a blood flow rate increases as a heart rate increases, the voltage corresponding to the y axis of the graph increases and peak point spacing of the graph become narrow as the heart rate increases. That is, a gap between peak points of the graph corresponds to a heartbeat cycle.

When the heartbeat in the aforementioned state is measured, the dedicated MCU 320 may be controlled not to activate the main MCU 330. That is, the dedicated MCU 320 can activate the main MCU 330 when a graph pattern according to a blood flow rate sensed through the light-emitting unit 311 and the light-receiving unit 312 differs from the graph pattern corresponding to the stable state of the user, for example, when the interval between peak points is shorter than a predetermined threshold time, a voltage value increases to higher than a predetermined reference voltage, and the like. Accordingly, the controller can receive the biosignal when the user is excited through the activated main MCU 330.

That is, the sensing unit 300 senses an excited state of the user through the graph pattern. (b) of FIG. 8c shows a graph pattern sensed when the user is in an excited state with positive emotion. Here, a positive emotion refers to gratitude, pleasure, love, happiness, etc.

When the graph pattern is a regular and smooth curve, the controller can predict the emotional state of the user as a positively excited state. That is, when voltage values of peak points are substantially similar, peak point spacing is relatively uniform, and regions corresponding to peak points are curved, the user's emotion can be determined to be a positive emotion.

Although not shown, a pattern in which a measured voltage value gradually increases can be generated when the user is in an excited state. Accordingly, it is possible to confirm that the user is not in a stable state.

Referring to (c) of FIG. 8c, the controller can sense a negatively excited state of the user when the graph pattern is irregular. For example, when voltages of peak points are not uniform, peak point spacing is irregular, and the shape of a peak is sharp, a negatively excited state of the user can be sensed. Here, a negatively excited state may correspond to anger, anxiety, fear and the like.

That is, when the peak point spacing becomes narrower than that in a stable state (or when the voltage value of a peak point increases), the controller can sense an excited state of the user and determine whether the excited state is positive or negative from the shape of the graph pattern. Accordingly, the user can control the mobile terminal in different manners according to a positively excited state or a negatively excited state.

The controller 180 may combine emotion data based on a positive state of the user, which is predicted on the basis of the biosignal received through the sensing unit 300, and the input clapping pattern to control whether to record the event with respect to the current situation.

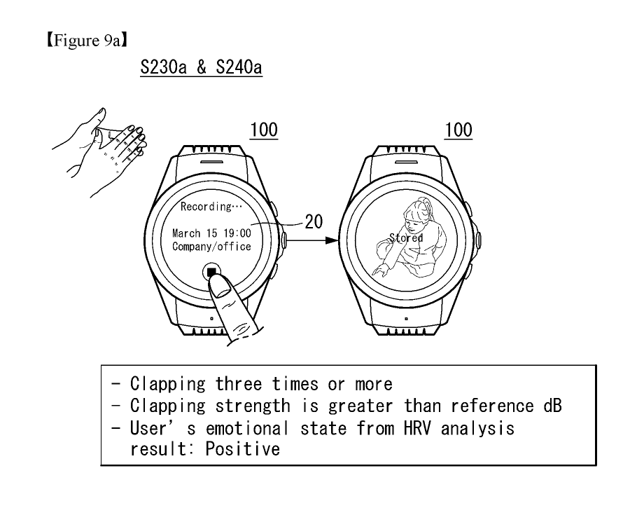

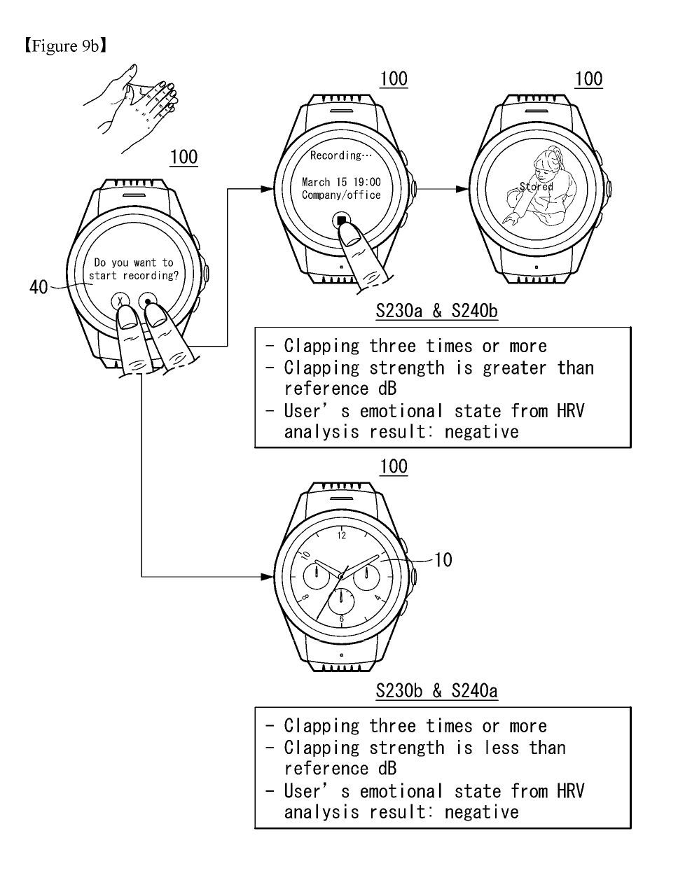

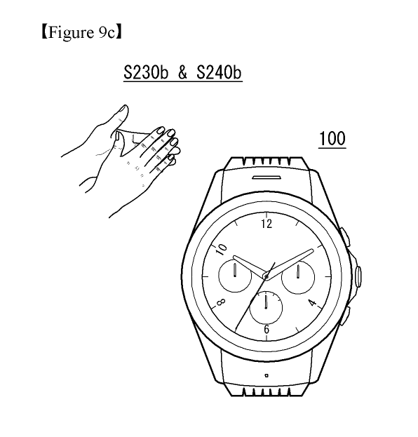

FIGS. 9a to 9c are diagrams for describing an example of controlling recording depending on a clapping pattern and a user's emotional state according to the second embodiment of the present invention.

Referring back to FIG. 7, the controller 180 may automatically perform recording (S260) when clapping sound is higher than a predetermined strength and the user's emotional state is determined to be a first state (positive state) (S230a and S240a). Referring to FIG. 9a, when the number of times of sensed clapping is 3 or more, clapping strength is equal to or greater than a reference value set by the user, and the user's emotional state is determined to be a positive state, the controller 180 may display a recording execution screen 20 on the display unit 151. The controller 180 may store the recorded event when a recording end button is selected. The case shown in FIG. 9a may correspond to a case in which the user intends to consciously record the current situation (event).

In FIG. 7, when the clapping strength is equal to or greater than a predetermined strength and the user's emotional state is determined to be a second state (negative state) (S230a and S240b), the controller 180 may not automatically execute recording and may provide an inquiry window through which the user can select whether to activate recording (S251).

When the clapping strength is less than the predetermined strength and the user's emotional state is determined to be the first state (positive state) (S230b and S240a), the controller 180 may provide the inquiry window through which the user can select whether to activate recording (S251).

Here, a case in which the clapping intensity is less than the predetermined strength may include a case in which clapping sound is too weak to be sensed. However, the sensing unit can detect a biosignal through which a user's emotional state can be determined from the gesture of the user who is clapping although clapping sound is weak.

Referring to FIG. 9b, when clapping sound is loud but the user's emotional state is a negative state or clapping sound is low but the user's emotional state is a positive state, automatic recording may not be executed and the recording function may be activated according to user selection (40). A recording screen may be provided to the display unit 151 when the recording function is executed according to user selection, and the recorded event may be stored when recording is ended. If the recording function is not executed according to user selection, a screen 10 according to a watch mode may be provided to the display unit 151.

Referring back to FIG. 7, when the clapping strength is less than the predetermined strength and the user's emotional state is the second state (negative state), recording is not started (S230b and S240b). Referring to FIG. 9c, when clapping sound generated by the user is input but it is determined that the clapping sound is weak and the user's emotional state is negative from analysis of the clapping pattern, the controller 180 may provide the watch mode screen 10 to the display unit 151 or continuously provide the screen when the clapping sound is sensed.

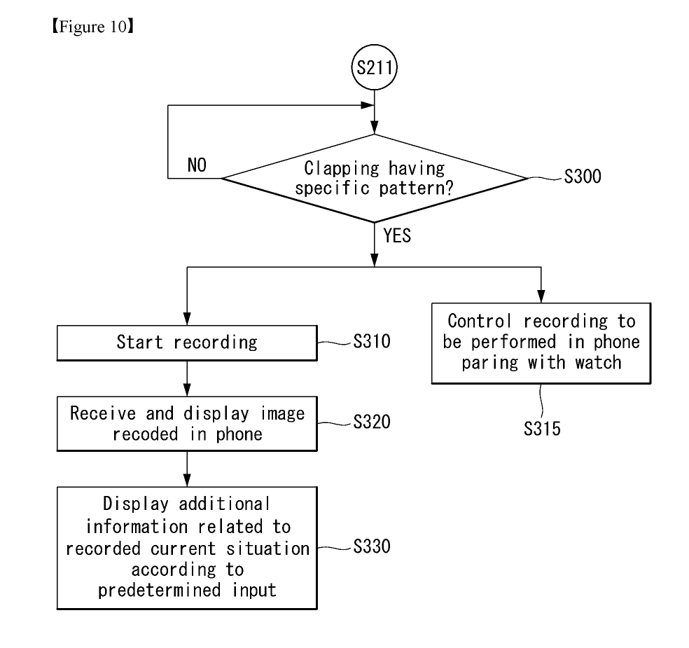

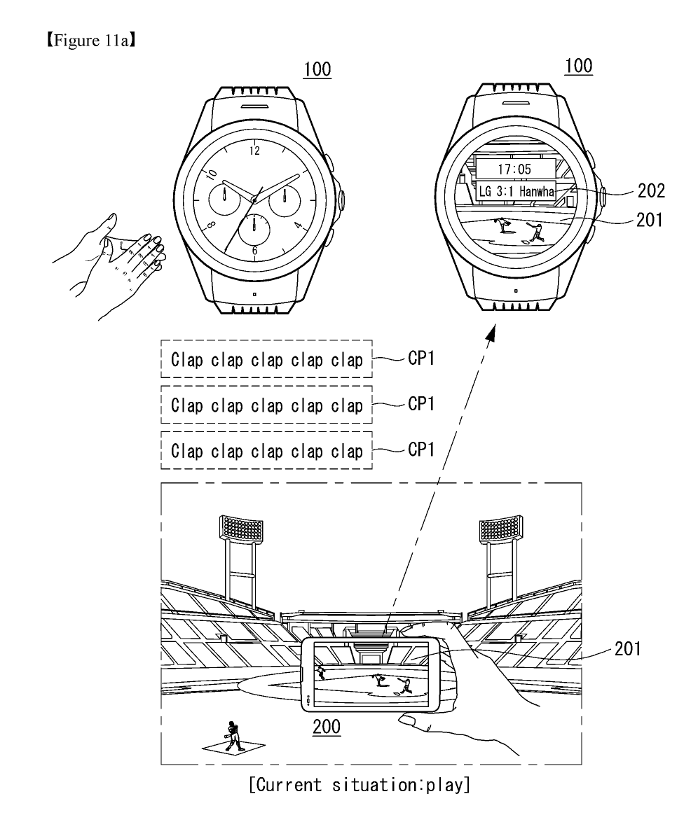

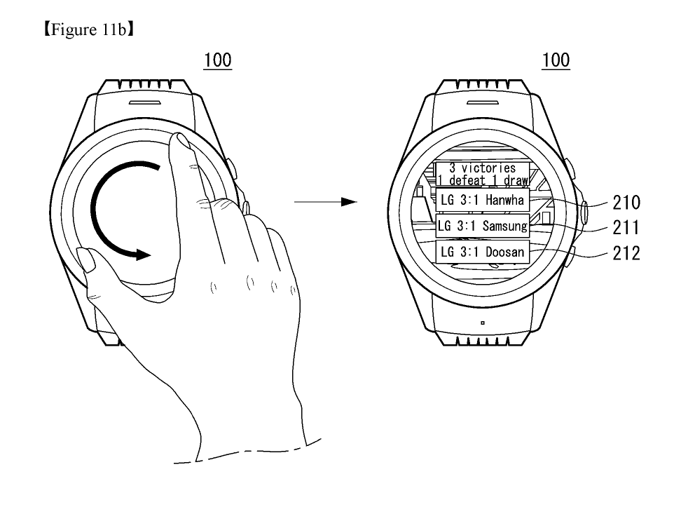

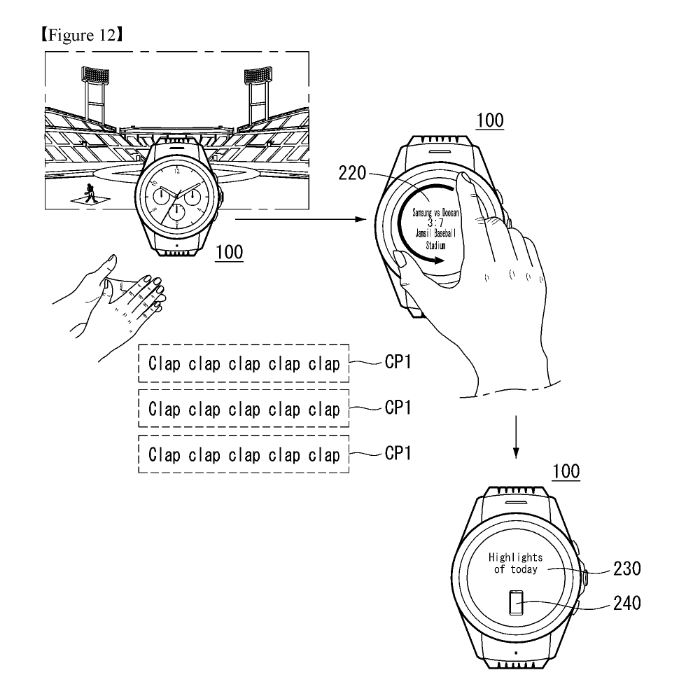

FIG. 10 is a flowchart of a method of controlling a mobile terminal according to a third embodiment of the present invention. FIGS. 11a to 12 are diagrams for describing an example of providing additional information of a recorded event according to the third embodiment of the present invention.

The method for controlling a mobile terminal according to the third embodiment of the present invention can be implemented in the mobile terminal 100 described above with reference to FIGS. 1 to 3. Hereinafter, the method for controlling a watch-type mobile terminal according to the third embodiment of the present invention and operations of the watch-type mobile terminal 100 for implementing the same will be described in detail with reference to the drawings. The third embodiment of the present invention can be implemented on the basis of the first embodiment and/or the second embodiment or according to a combination thereof.

Referring to FIG. 10, the controller 180 may analyze a clapping sound pattern input according to a gesture of the user (S211). Upon determining that clapping sound in a predetermined pattern has been input from analysis results (S300), the controller 180 may activate the recording function to start recording (S310) and, simultaneously, output a control signal for causing a paired external electronic device 200 to perform recording to the external electronic device 200 (S315).

Clapping in the predetermined pattern may include clapping sound of audience in a stadium or a concert hall or clapping sound having a specific rhythm. For example, a clapping pattern used for cheering may have a specific pattern. In this case, the controller 180 may not record the stage of the stadium or the concert hall as a desired image due to restrictions on the view angle of the camera included in the mobile terminal 100. The controller 180 may drive the camera of the external electronic device 200 paired with the watch-type mobile terminal 100 in response to the clapping sound having a specific rhythm and transmit, to the external electronic device 200, a control signal for controlling images and sounds of the stage of the stadium or the concert hall to be recorded through the camera of the external electronic device 200.

The controller 180 may receive an image recorded through the external electronic device 200 from the external electronic device 200 and provide the image to the display unit 151 (S320). That is, the image recorded through the external electronic device 200 in real time can be displayed on the screen of the watch-type mobile terminal 100.

The control signal may include a signal for causing the recorded result to be transmitted to the watch-type mobile terminal 100. Accordingly, the event recorded in the external electronic device 200 is transmitted to the watch-type mobile terminal 100 and the image and sound corresponding to the event can be reproduced in the watch-type mobile terminal 100.

Upon reception of a predetermined input, the controller 180 may receive additional information related to the recorded current situation through the communication unit and provide the additional information to the display unit 151 (S330).

The predetermined input is a rotating input applied to a bezel region of the display unit 151 and may include an input of touching two points in the bezel region and rotating the points clockwise or counterclockwise.

Referring to FIG. 11a, a situation in which the user wearing the watch-type mobile terminal 100 on a wrist watches a baseball game is assumed. The controller 180 receives a clapping pattern CP1 having a specific rhythm. The controller 180 drives the camera of the paired external electronic device 200 and transmits a control signal for activating the recording function of the camera to the external electronic device 200 upon sensing the clapping pattern. The external electronic device 200 can automatically drive the camera to record an image 201 of the baseball game upon reception of the control signal.

The controller 180 may receive the image 201 being recoded or having been recorded in the external electronic device 200 and display the image 201 on the display unit 151. The controller 180 may also provide additional information 202 related to the recorded event to the display unit 151. For example, the additional information 202 may include score information of the baseball game the user is watching.

Referring to FIG. 11b, the controller 180 may display information 210, 211 and 212 of previous games on the display unit 151 upon sensing an input of touching two arbitrary points in the bezel region of the display unit 151 and rotating the touched points counterclockwise. The additional information related to the current event may be received from an external server through the communication unit. That is, the controller 180 may determine the type of the currently recorded event according to the input clapping pattern, access the Internet to search for additional information related to the event and provide searched additional information to the user according to user input (e.g., bezel rotating input) requesting the additional information.

Referring to FIG. 12, the additional information may include information about baseball games played in other stadiums.

The controller 180 may display results of baseball games played in other stadiums on the display unit 151 in real time through the Internet upon sensing the clapping pattern CP1 having a predetermined rhythm. The controller 180 may display a highlight of the baseball game that the user has watched on the display unit 151 upon reception of a rotating input applied to the bezel region of the display unit 151. The screen displaying the highlight may include an external device icon 240, and the image of the highlight is provided through the paired external electronic device 200 upon selection of the icon 240.

An example of activating the recording function through clapping sound of the user has been described. According to an embodiment of the present invention, a recorded event may be retrieved when a predetermined input is received after the recording function is ended.

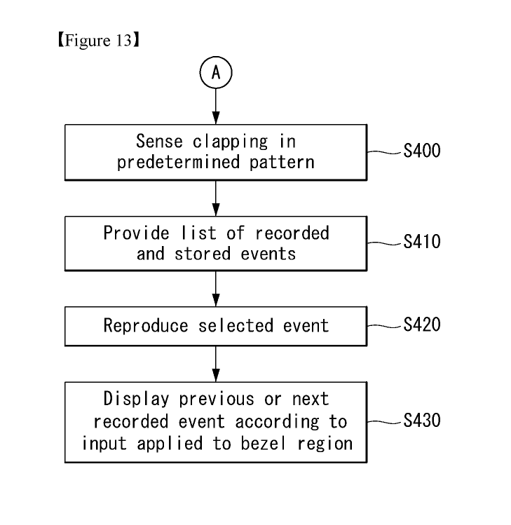

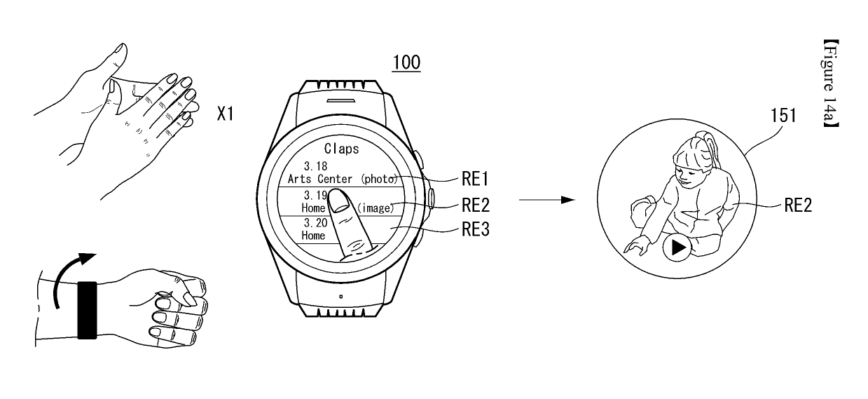

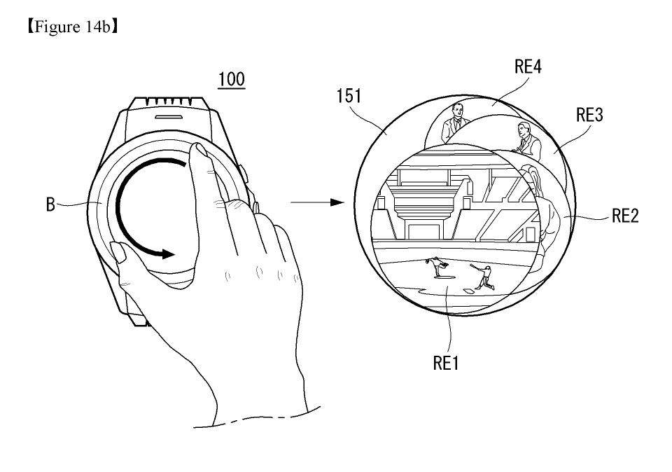

FIG. 13 is a flowchart of a method of controlling a mobile terminal according to a fourth embodiment of the present invention. FIGS. 14a and 14b are diagrams for describing an example of implementing a method of retrieving a recorded event according to the fourth embodiment of the present invention.

The method for controlling a watch-type mobile terminal according to the fourth embodiment of the present invention can be implemented in the watch-type mobile terminal 100 described above with reference to FIGS. 1 to 3. Hereinafter, the method for controlling a watch-type mobile terminal according to the fourth embodiment of the present invention and operations of the watch-type mobile terminal 100 for implementing the same will be described in detail with reference to the drawings. The fourth embodiment of the present invention can be implemented on the basis of the first embodiment, the second embodiment and/or the third embodiment or according to a combination thereof.

Referring to FIG. 13, the controller 180 senses clapping in a predetermined pattern (S400). The controller 180 may provide a list or recorded and stored events to the display unit 151. The controller 180 may reproduce an event selected from the list (S420). In addition, the controller 180 may sequentially provide previously recorded events to the display unit 151 according to (clockwise or counterclockwise) rotating input applied to the bezel region of the display unit 151.

Referring to FIG. 14a, the input for retrieving a recorded event may include an input of one-time clapping or an input of tilting the user's wrist on which the watch-type mobile terminal 100 is worn in a specific direction. The controller 180 may provide a list of previously recorded events RE1, RE2 and RE3 to the display unit 151. When a specific event RE2 is selected, the selected event can be reproduced on the screen.

Referring to FIG. 14b, the controller 180 may provide thumbnails RE1, RE2, RE3 and RE4 of a plurality of recorded events to the display unit 151 upon sensing an input of rotating the bezel region of the display unit 151 counterclockwise. The thumbnails may be displayed on the display unit 151 in a spiral form.

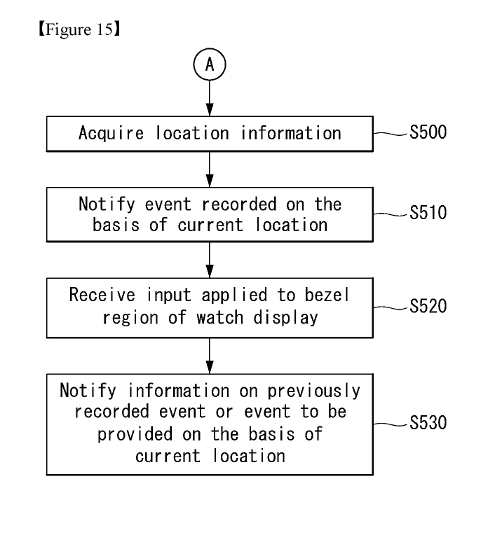

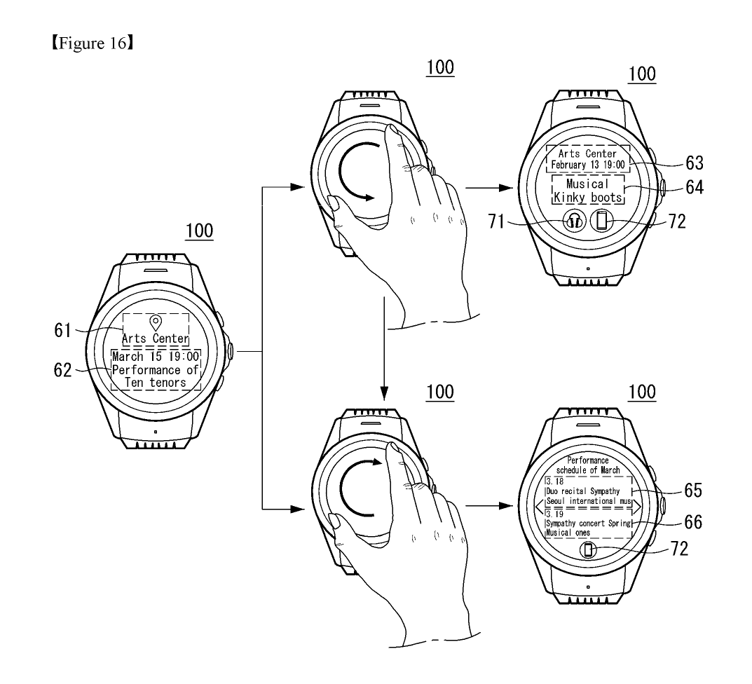

FIG. 15 is a flowchart of a method of controlling a mobile terminal according to a fifth embodiment of the present invention. FIG. 16 is a diagram for describing an example of providing recorded event information having location information tagged thereto according to the fifth embodiment of the present invention.

The fifth embodiment of the present invention can be implemented on the basis of at least one of the first to fifth embodiments or according to a combination thereof.

According to one embodiment of the present invention, the mobile terminal 100 may acquire the current location of the mobile terminal 100 through the location information module, and the acquired location may be tagged when the recording function is activated through clapping sound according to the above-described embodiments.

Referring to FIG. 15, a state in which recording is completed according to clapping sound in a predetermined pattern through the above-described embodiments is assumed. The recording operation may be performed while a first location acquired through the location information module is tagged when the watch-type mobile terminal 100 is positioned in the first location, and location information may be tagged and stored.

The controller 180 may acquire current location information of the mobile terminal 100 in a state of storing the recording event to which the first location has been tagged (S500).

The controller 180 may search the memory for an event which has been recorded on the basis of the current location (first location). When there is a result to which the first location has been tagged among recorded events, the controller 180 may notify the user of presence of the event recorded on the basis of the current location (S510). The controller 180 may notify the user of presence of the event recorded on the basis of the current location by providing a predetermined alarm signal or a pop-up window displayed on the display unit 151.

The controller 180 may receive a (clockwise or counterclockwise) rotating input applied to the bezel region of the display unit 151 of the watch-type mobile terminal 100 (S520) and provide information on an event recorded in the past or an event which will be provided in the future according to the rotating input (S530).

Referring to FIG. 16, when a location acquired through the location information module is the first location 61 (Arts Center), the controller 180 may search the memory for recorded events to which the first location 61 has been tagged. The controller 180 may display information on a recorded event 62 to which the first location 61 has been tagged on the display unit 151.

Upon reception of an input of rotating the bezel region of the display unit 151 counterclockwise, the controller 180 may provide information on other recorded events 63 and 64 recorded at the first location 61 to the display unit 151. Meanwhile, the controller 180 may provide an earphone icon 71 and an external device icon 72 such that the user can select an output source or an output method of a recorded event. When the earphone icon 71 is selected, the controller 180 controls the mobile terminal 100 to output a stored event. When the external device icon 72 is selected, the controller 180 may control the external electronic device 200 pairing with the mobile terminal 100 to reproduce the stored event.

Upon reception of an input of rotating the bezel region of the display unit 151 clockwise, the controller 180 may display information on other events 65 and 66 which will be provided in the future at the first location 61 on the display unit 151. When the external device icon 72 is selected, the controller 180 may transmit information on a link through which the events that will be provided in the future at the first location 61 are provided to the external electronic device 200 pairing with the mobile terminal 100 and allow the user to confirm detailed information about the events through the external electronic device 200.

According to one embodiment of the present invention, when the watch-type mobile terminal 100 is released from the user's wrist, the mobile terminal may sense the releasing situation and display a previously recorded event in various methods by being triggered by the sensed situation.

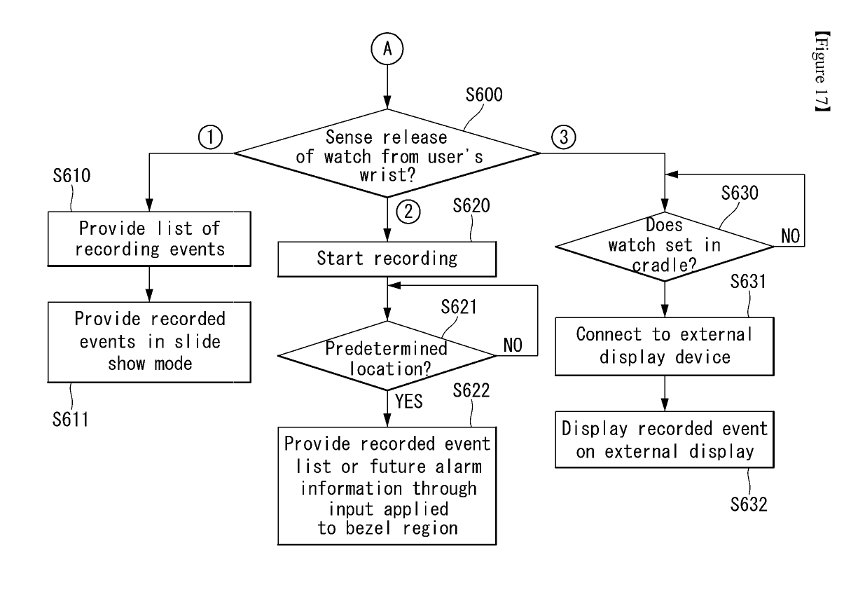

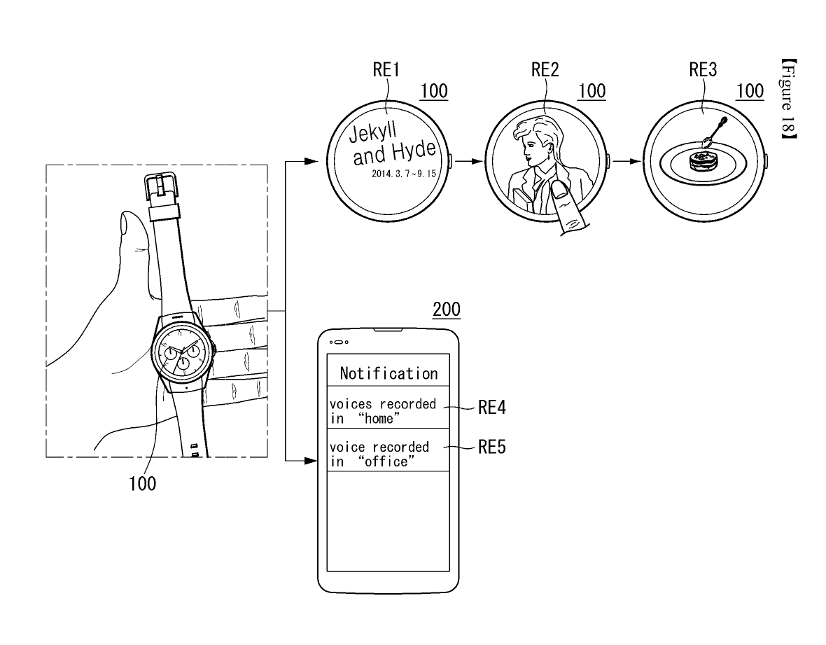

FIG. 17 is a flowchart of a method of controlling a mobile terminal according to a sixth embodiment of the present invention. FIGS. 18 to 20 are diagrams for describing an example of implementing a method of displaying a recorded event in a state in which the watch-type mobile terminal has been released from the user's wrist according to the sixth embodiment of the present invention.

The sixth embodiment of the present invention can be based on at least one of the first to fifth embodiments and implemented according to a combination thereof.

Referring to FIG. 17, a state in which recording is completed according to clapping sound in a predetermined pattern through the above-described embodiment is assumed. The controller 180 may sense release of the watch-type mobile terminal 100 from the user's wrist (S600).

The controller 180 may provide a list of a plurality of recorded events stored in the memory to the display unit 151 (S610) upon sensing release of the watch-type mobile terminal from the user's wrist (S600-\textcircled{1}) after completion of recording.

Further, the controller 180 may provide the recorded events in a slide show mode when reproducing the events (S611). Referring to FIG. 18, when the user go back home and releases the watch-type mobile terminal 100, a plurality of events recorded for one day may be provided in a slide mode. Accordingly, first, second and third recorded events RE1, RE2 and RE3 are sequentially displayed on the display unit 151 in slide order.

Particularly, when the location at which the watch-type mobile terminal 100 is released is a predetermined place (e.g., home), the external electronic device 200 pairing with the watch-type mobile terminal 100 may be controlled to display a list of recorded events RE4 and RE5, as shown in FIG. 18.

Referring back to FIG. 17, the controller 180 may acquire location information (S620) upon sensing release of the watch-type mobile terminal from the user's wrist after completion of recording (S600-\textcircled{2}).

The controller 180 may provide a list of recorded events or alarm information about future events to the display unit 151 according to an input applied to the bezel region when located at a predetermined location (e.g., home) (S620).

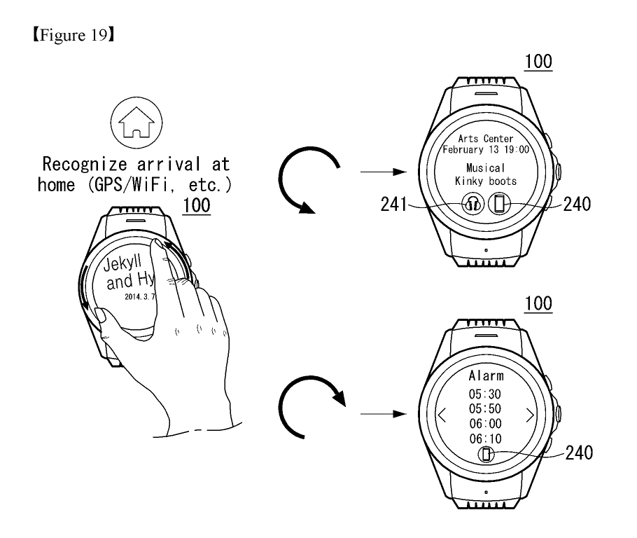

For example, referring to FIG. 19, the controller 180 may display events recorded for one day and provide icons 241 and 240 through which recorded sounds and images can be reproduced upon reception of a counterclockwise rotating input applied to the bezel region of the display unit 151. In addition, the controller 180 displays notification information through which alarm, schedule and the like of tomorrow can be checked on the display unit 151 upon reception of a clockwise rotating input applied to the bezel region of the display unit 151. Further, the controller 180 may also provide the icon 240 through which detailed information can be confirmed through the external electronic device 200 pairing with the mobile terminal.

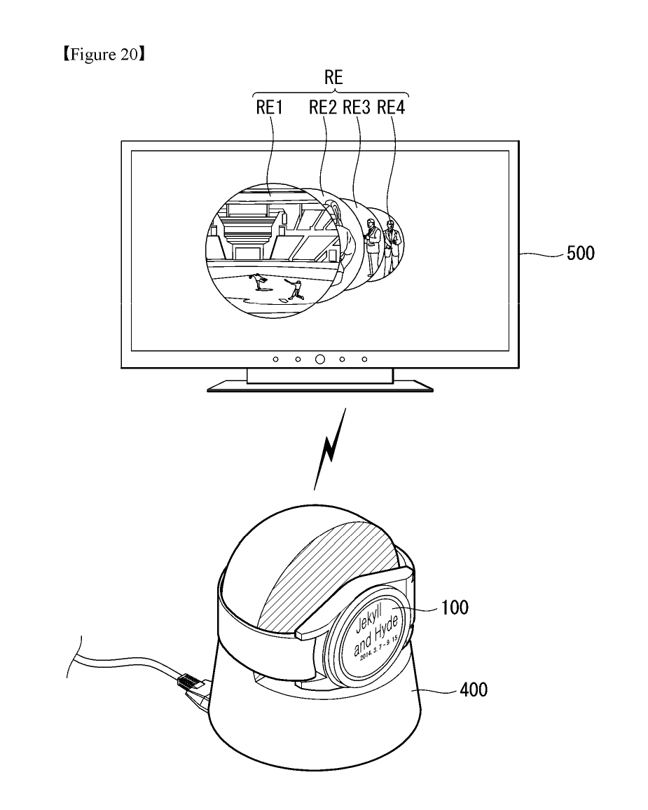

Referring to FIGS. 17 and 20, the controller 180 senses release of the watch-type mobile terminal from the user's wrist (S600-\textcircled{3}) and, simultaneously, senses setting of the watch-type mobile terminal 100 in a cradle 400 to enter a charging mode (S630) after completion of recording. The watch-type mobile terminal can be provided with power through the cradle 400 and the user can attempt to connect the mobile terminal 100 to an external display device 500 while the mobile terminal 100 operates in the charging mode (S631).

The watch-type mobile terminal 100 and the external display device 500 may be connected to each other in the form of an N-screen through which they share a screen or in such a manner that the screen of the watch-type mobile terminal 100 is mirrored to the display of the external display device 500. However, connection of the two devices is not limited to these examples and can be achieved in any connection form in which they can share a screen.

The controller 180 may control the external display device 500 to display at least one recorded event RE (S632).

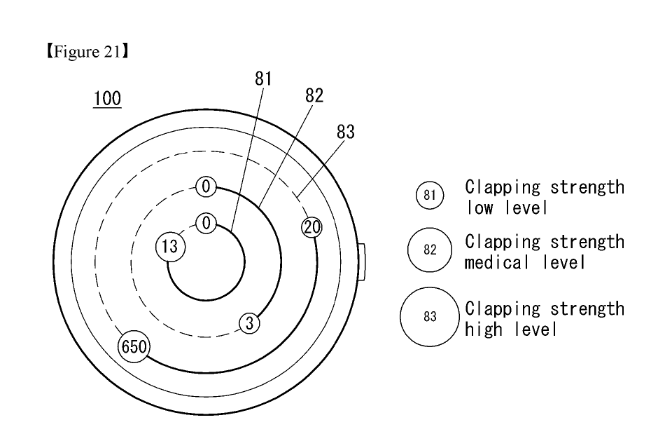

FIG. 21 is a diagram for describing an example of displaying clapping recommended for the user as a graphical object according to one embodiment of the present invention. Referring to FIG. 21, the controller 180 may provide clapping patterns recommended for the user for one day, which are set by the user. For example, the controller 180 may display, on the display unit 151, a first graphical object 81 corresponding to a first clapping strength (low level), a second graphical object 82 corresponding to a second clapping strength (medium level) and a third graphical object 83 corresponding to a third clapping strength (high level) in the form of circular lines according to clapping strength. Further, information 92 on the target number of times of clapping and information 91 on the number of times of clapping which has been performed with respect to each clapping strength may be displayed on the display unit 151 through the graphical objects. The first, second and third graphical objects may be displayed with different display properties to call attention of the user to a clapping gesture. The graphical objects may be displayed on the display unit 151 when the user raises their wrist after clapping.

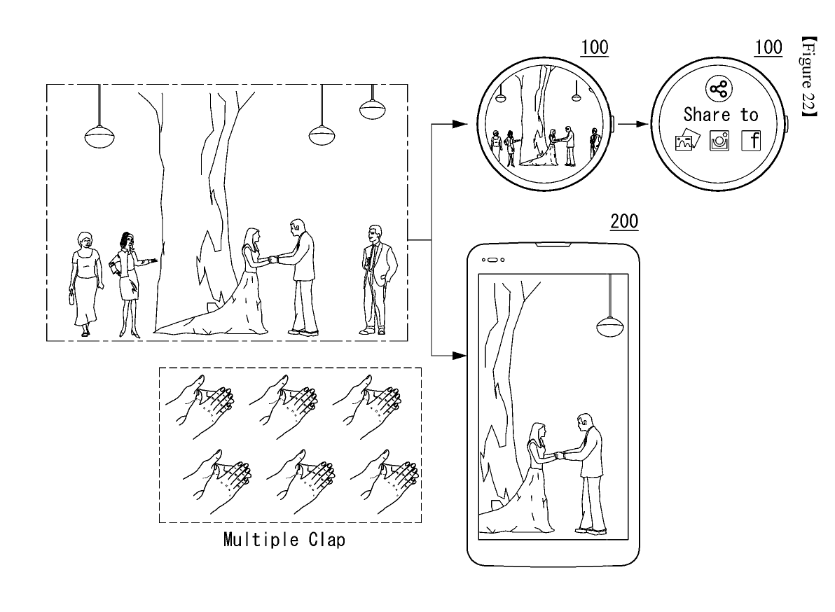

FIG. 22 is a diagram for describing an example of sharing a recorded event according to an embodiment of the present invention. Referring to FIG. 22, when clapping sound is continuously input, the controller 180 may determine the current situation as a celebration event. Accordingly, the controller 180 activates the microphone and the camera included in the mobile terminal 100 to perform recording or simultaneously performs recording through the camera of the mobile terminal 100 and recording through the camera of the external electronic device 200 pairing with the mobile terminal 100. Upon completion of recording, the controller 180 may display an image including objects that can be shared on the display unit 151. The objects that can be shared may include a messenger application icon, an SNS application icon, an e-mail application icon and the like.

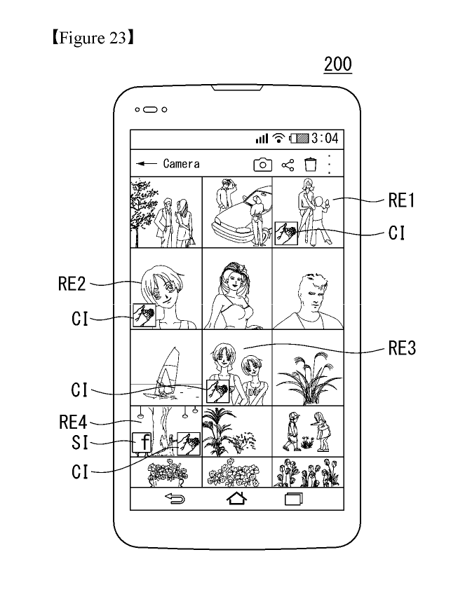

FIG. 23 is a diagram for describing an example of storing and displaying a recorded event according to an embodiment of the present invention. Referring to FIG. 23, the controller 180 may store recorded event in the memory and then retrieve stored events through a gallery application. The controller 180 may display content recorded according to clapping sound in a manner in which the content is discriminated from other pieces of content upon execution of the gallery application. For example, the controller 180 may add a predetermined indicator C1 to content RE1, RE2, RE3 and RE4 recorded according to clapping sound and display the content RE1, RE2, RE3 and RE4. When the content recorded according to clapping sound is shared through a predetermined sharing application, a sharing icon SI may be added to the content.

An example in which a clapping pattern and a user's emotion state are analyzed through clapping sound input according to a gesture of the user and the current situation is recorded has been described. However, the present invention may provide various sensible user interfaces in consideration of a user's emotional state in addition to the above-described operation of sensing clapping sound of the user to perform recording.

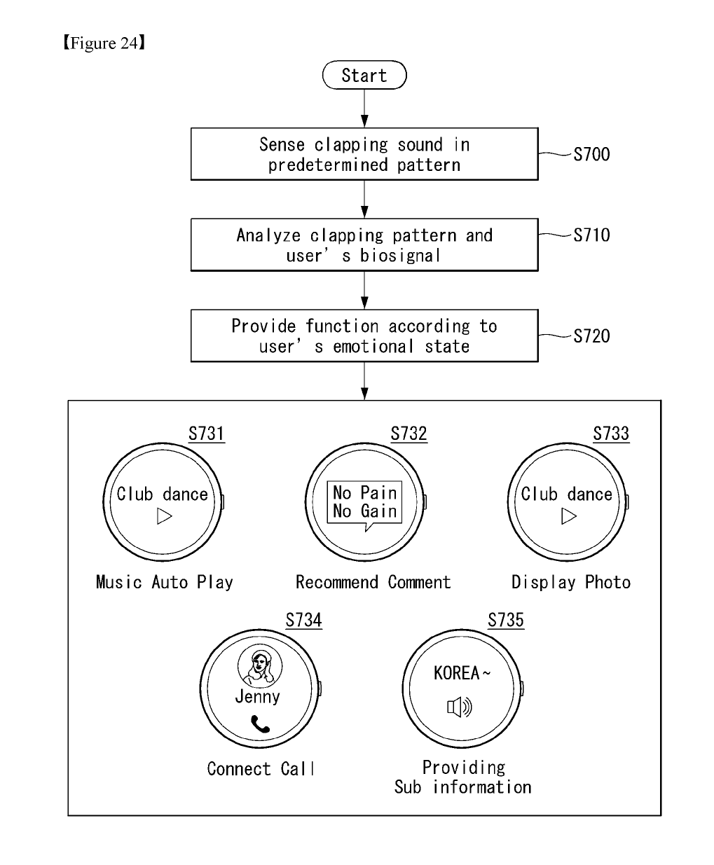

FIG. 24 is a diagram for describing an example of providing appropriate information to a user according to a clapping pattern and an emotional state of the user according to an embodiment of the present invention. Referring to FIG. 24, the controller 180 senses clapping sound in a predetermined pattern (S700) and analyzes the clapping pattern and a biosignal of the user (S710). The controller 180 may determine a user's emotional state according to the biosignal of the user and provide various functions according to the user's emotional state (S720).

The controller 180 provides an appropriate function according to the user's emotional state in consideration of clapping strength, clapping pattern, a heart rate variation, a body temperature variation, surrounding sound, etc.

For example, upon sensing a predetermined clapping pattern while music is played, the controller 180 can change a music play order and provide the changed music play order in consideration of the user's emotion when the user is clapping (S731). In addition, the controller 180 may automatically provide information for cheering the user up in the current situation according to the sensed clapping pattern or user's emotional state, for example (S732). For example, the controller 180 may display a family picture or the like such that the user refreshes themselves upon determining that the user does not feel good through the sensed clapping pattern (S733). For example, the controller 180 may control the mobile terminal to automatically call a phone number set for emergencies upon recognition of an emergency through the sensed clapping pattern (S734). For example, the controller 180 may provide sound corresponding to the sensed clapping pattern (S735).

The above-described method of controlling the mobile terminal may be written as computer programs and recorded in a computer readable recording medium.

The method of controlling the mobile terminal according to the present invention may be executed through software. When the method is executed through software, components of the present invention are code segments that perform required tasks. Programs or code segments may be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include a DVD, RAM, CD-ROM, DVD+ROM, DVD−RAM, magnetic tapes, floppy disks, hard disks, optical data storage devices, etc. The computer readable recording medium may also be distributed over network coupled computer systems so that the computer readable code is stored and executed in a distribution fashion.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### REFERENCE SIGNS LIST

10: Personal radio environment

100, 300: Watch-type mobile terminal 151: Display unit

180: Controller 200: External electronic device

1-20. (canceled)

21. A watch-type mobile terminal, comprising:
an input unit;
a memory configured to store information; and
a controller configured to:
receive an audio signal via the input unit;
detect a plurality of clapping sounds included in the received audio signal;
start recording information via the input unit when the detected plurality of clapping sounds corresponds to a clapping pattern stored in the memory; and
end the recording and store the recorded information in the memory in response to a recording end event.

22. The watch-type mobile terminal according to claim 21, wherein:
the input unit comprises at least a microphone or a camera; and
the controller is further configured to execute an application for recording audio via the microphone or an application for recording images via the camera to record the information.

23. The watch-type mobile terminal according to claim 21, wherein the recording end event comprises at least:
another audio input received via the input unit during the recording and corresponding to the stored clapping pattern;
the recording reaching a predetermined threshold time; or
a change of location of the watch-type mobile terminal detected by a location information module of the watch-type mobile terminal.

24. The watch-type mobile terminal according to claim 21, further comprising:
a body;
a band coupled to the body and configured to secure the watch-type mobile terminal to a user;
a display disposed at a front side of the body and configured to display information; and
a sensor disposed at a rear side of the body or an inside surface of the band and configured to sense a biometric signal of the user when the watch-type mobile terminal is worn by the user,
wherein the controller is further configured to determine an emotional state of the user based on the sensed biometric signal.

25. The watch-type mobile terminal according to claim 24, wherein the biometric signal comprises a heartbeat signal of the user.

26. The watch-type mobile terminal according to claim 24, wherein the controller is further configured to detect a number of claps of the detected plurality of clapping sounds, a strength of the plurality of clapping sounds, and a sequence of the plurality of clapping sounds.

27. The watch-type mobile terminal according to claim 24, wherein the controller is further configured to control the recording based on a pattern of the plurality of clapping sounds and the determined emotional state of the user.

28. The watch-type mobile terminal according to claim 27, wherein the controller is further configured to start recording information when the strength of the plurality of clapping sounds is greater than or equal to a predetermined strength and the determined emotional state of the user is a first state.

29. The watch-type mobile terminal according to claim 27, wherein the controller is further configured to cause the display to display a prompt for receiving input to start recording information when:
the strength of the plurality of clapping sounds is greater than or equal to a predetermined strength and the determined emotional state of the user is a second state; or
the strength of the plurality of clapping sounds is less than a predetermined strength and the emotional state of the user is a first state.

30. The watch-type mobile terminal according to claim 26, wherein the recording is not started and a watch mode screen is displayed on the display when the strength of the plurality of clapping sounds is less than a predetermined strength and the emotional state of the user is a second state.

31. The watch-type mobile terminal according to claim 21, further comprising a communication unit configured to perform communication with a paired external electronic device,
wherein the stored clapping pattern comprises a predetermined number of clapping sounds having a specific rhythm, and
wherein the controller is further configured to:
transmit a signal to the paired external electronic device to cause a recording unit of the external electronic device to start recording when the plurality of clapping sounds corresponds to the stored clapping pattern;
receive recording information from the paired external electronic device via the communication unit; and
cause a display of the watch-type mobile terminal to display the received recording information.

32. The watch-type mobile terminal according to claim 31, wherein the controller is further configured to:
receive, via the communication unit, additional information of an event related to the received recording information or an event at the paired external electronic device; and
cause the display to display the received additional information when a predetermined input is received to a bezel region of the watch-type mobile terminal.

33. The watch-type mobile terminal according to claim 21, wherein the controller is further configured to cause a display of the watch-type mobile terminal to display a list of a plurality of recorded events stored in the memory when:
another plurality of clapping sounds is received and is determined to match a second predetermined clapping pattern; or
it is determined that the watch-type mobile terminal is no longer secured to a user after the recording is ended.

34. The watch-type mobile terminal according to claim 33, wherein the controller is further configured to cause the display to display the plurality of recorded events sequentially according to a predetermined input applied to a bezel region of the watch-type mobile terminal.

35. The watch-type mobile terminal according to claim 21, further comprising a location information module, wherein the controller is further configured to store the recorded information to be tagged with a location acquired through the location information module.

36. The watch-type mobile terminal according to claim 35, wherein the controller is further configured to search the memory for event information recorded at a first location and to cause a display of the watch-type mobile terminal to display results of the search when a location of the watch-type mobile terminal corresponds to the first location.

37. The watch-type mobile terminal according to claim 36, wherein the controller is further configured to cause the display to display information on future events associated with the first location according to another predetermined input applied to the bezel region.

38. The watch-type mobile terminal according to claim 21, further comprising a communication unit configured to perform communication with an external display device,
wherein the controller is further configured to:
establish a communication link with the external display device via the communication unit when the watch-type mobile terminal is mounted to a docking device to enter a charging mode; and
cause at least one recorded event stored in the memory to be displayed on the external display device.

39. A method of controlling a watch-type mobile terminal, comprising:
receiving an audio signal;
detecting a plurality of clapping sounds included in the received audio signal;
starting recording information when the detected plurality of clapping sounds corresponds to a clapping pattern stored in a memory; and
ending the recording and storing the recorded information in the memory in response to a recording end event.

40. The method according to claim 39, further comprising:
sensing a biometric signal of a user when the watch-type mobile terminal is worn by the user;
determining an emotional state of the user based on the sensed biometric signal; and
controlling the recording based on a pattern of the plurality of clapping sounds and the determined emotional state of the user.
